(19) United States
(12) Patent Application Publication
(10) Pub. No.: US 2021/0105453 A1
(43) Pub. Date: Apr. 8, 2021

(54) PORTABLE ELECTRONIC DEVICE WITH MULTIPLE CAMERAS

(71) Applicant: Gareth Alexander McKenzie, Nassau (BS)

(72) Inventor: Gareth Alexander McKenzie, Nassau (BS)

(21) Appl. No.: 16/591,038

(22) Filed: Oct. 2, 2019

(51) Int. Cl. H04N 13/243; H04R 1/02; H04N 5/247; H04N 5/225; H04R 1/40; H04R 3/00

(52) U.S. Cl. CPC H04N 13/243; H04R 1/028; H04N 5/247; H04R 2499/15; H04R 1/406; H04R 3/005; H04R 2499/11; H04N 5/2256

(57) ABSTRACT

A portable electronic device with multiple cameras are disclosed. The device may be used for recording 360-degree images or video combined with spatial audio to provide an immersive recording and viewing experience. The electronic device may include a processor, a memory and at least ten cameras connected to it. The cameras may be placed on the front, rear, top, bottom, left and right sides of the electronic device. Each of the cameras may capture a plurality of images simultaneously and transmit them to the processor. Further, the processor may process these images to generate a 360-degree image or video output.

### BACKGROUND

Electronic communication devices such as mobile phones, tablets, phablets, and the like have gone through many stages of evolution over the past few decades. While first generation portable communication devices had big form factors with very limited calling capabilities, today's mobile phones are easy to carry and have abilities to perform much more than mere phone calls. Electronic communication devices available in the market today are capable of performing video calls in addition to voice calls. Furthermore, they have the capability to allow users to play games, access the internet, capture photos, record videos and the like. Such devices commonly referred to as “smart” devices (or smartphones in case of mobile phones) have a wide variety of such features and their utility goes beyond just being a device for making phone calls.

One of the most sought after features that are being included to such smart devices are cameras. Built-in cameras make use of the processing power and the memory of the electronic device to capture, store, and transmit images seamlessly. While smart devices are being designed and manufactured with cameras installed on their front and rear sides, such design limits their functionality to capture images in just two perspectives. Few devices also have two or three cameras on one side wherein images are simultaneously captured using these cameras to perceive parameters such as depth, color, angle, perspective, and the like. Furthermore, the images are stored locally in the device so that they can be accessed at a later point of time.

While, smart devices available in the market have immense scope to widen their functionalities in terms of using cameras, most of them are built merely with the idea to replace general purpose cameras. It will be advantageous to provide an electronic device which has cameras covering all possible angles so that the functionality of the device can be widened to include real time monitoring, surveillance, 360-degree image capture, and the like.

### BRIEF DESCRIPTION OF THE DRAWINGS

Examples are described in the following detailed description and in reference to the drawings, in which:

FIG. 1 is a front view 100 of a portable electronic device with multiple cameras.

FIG. 2 is a rear view 200 of the portable electronic device with multiple cameras.

FIG. 3 is an example perspective view 300 of the portable electronic device with multiple cameras.

FIG. 4 is another example perspective view 400 of the portable electronic device with multiple cameras,

FIG. 5 is another example perspective view 500 of the portable electronic device with multiple cameras.

FIG. 6 is another example perspective view 600 of the portable electronic device with multiple cameras.

### DETAILED DESCRIPTION

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a” “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

The terms “portable electronic device”, “electronic device”, “mobile phone”, “smart device”, and “smartphone” may be used interchangeably throughout this document. The terms used herein do not restrict the scope of this disclosure, they are used merely for the purpose of reference.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described may be included in at least that one example, but not necessarily in other examples.

The utility of the devices described herein will be explained further in detail in the following sections of this document referring to the figures.

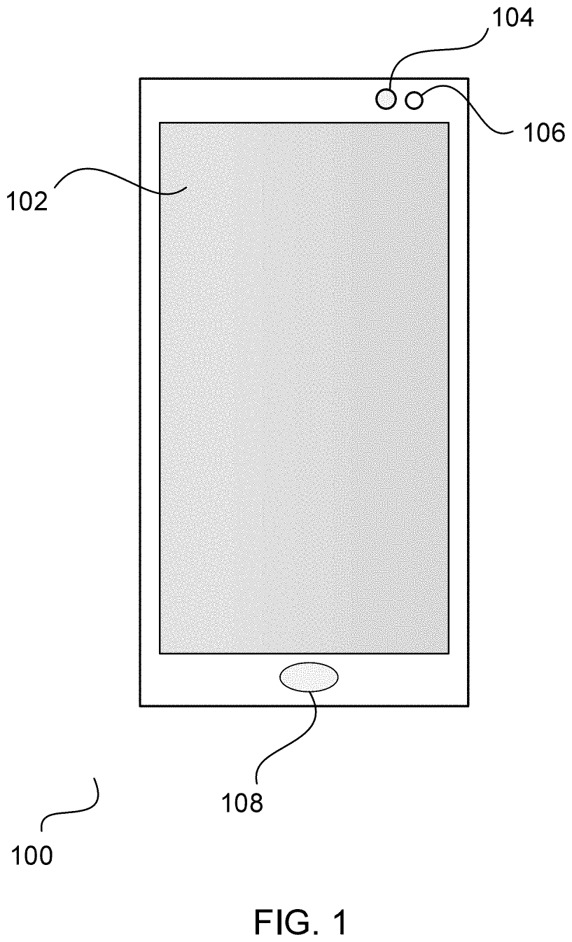

FIG. 1 is a front view 100 of a portable electronic device with multiple cameras. The screen 102 of the electronic device may be manufactured using known technologies such as LED, LCD, IPS, OLEO, QLED, and the like. The front side of the electronic device may comprise a first camera (C1) 104 and a flash (C1F) 106 associated with it. Further, the front side of the electronic device may include a power/lock button 108 that may be used to lock/unlock the device, reach home screen, etc., depending on the software functionality that is enabled.

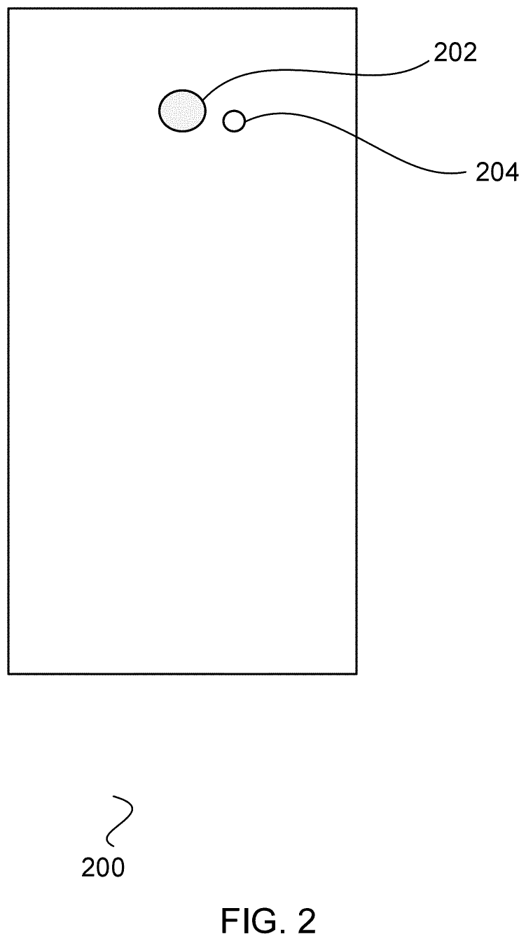

FIG. 2 is a rear view 200 of the portable electronic device with multiple cameras. The rear side of the electronic device may comprise a second camera (C2) 202 and a flash (C2F) 204 associated with it.

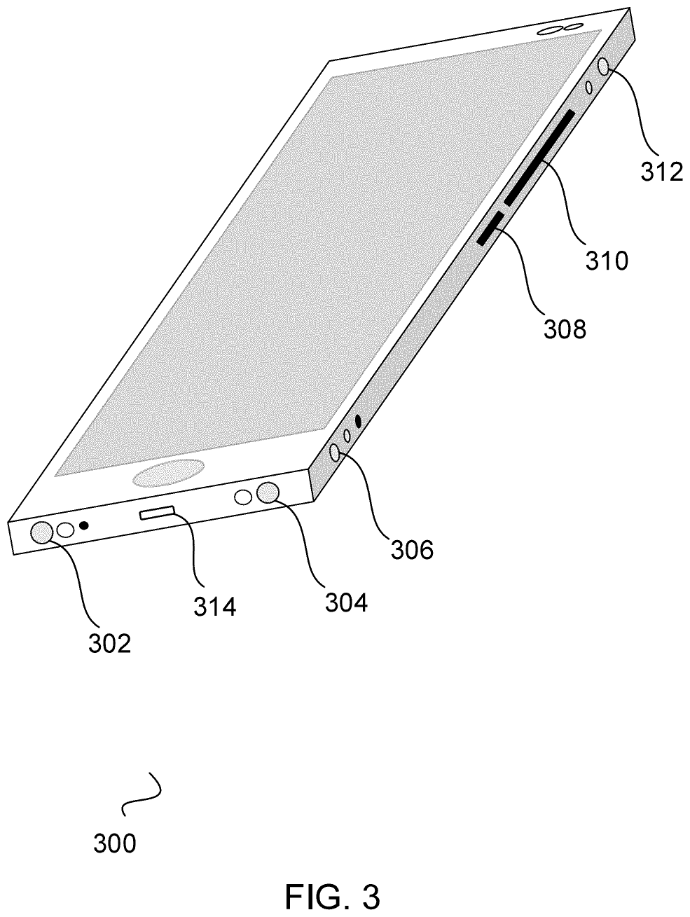

FIG. 3 is an example perspective view 300 of the portable electronic device with multiple cameras. The bottom side of the electronic device may comprise a third camera (C3) 302 and a fourth camera (C4) 304, both the cameras further have flashes associated with them. The bottom side further comprises a charging port 314. The right side of the electronic device may comprise a fifth camera (C5) 306 and a sixth camera (C6) 312, both the cameras further have flashes associated with them. The right side of the electronic device may further comprise a power button 308 and a volume control button 310. The buttons described herein may also be placed on the left hand side or any other side of the electronic device. The buttons may also be replaced with software based buttons in one example.

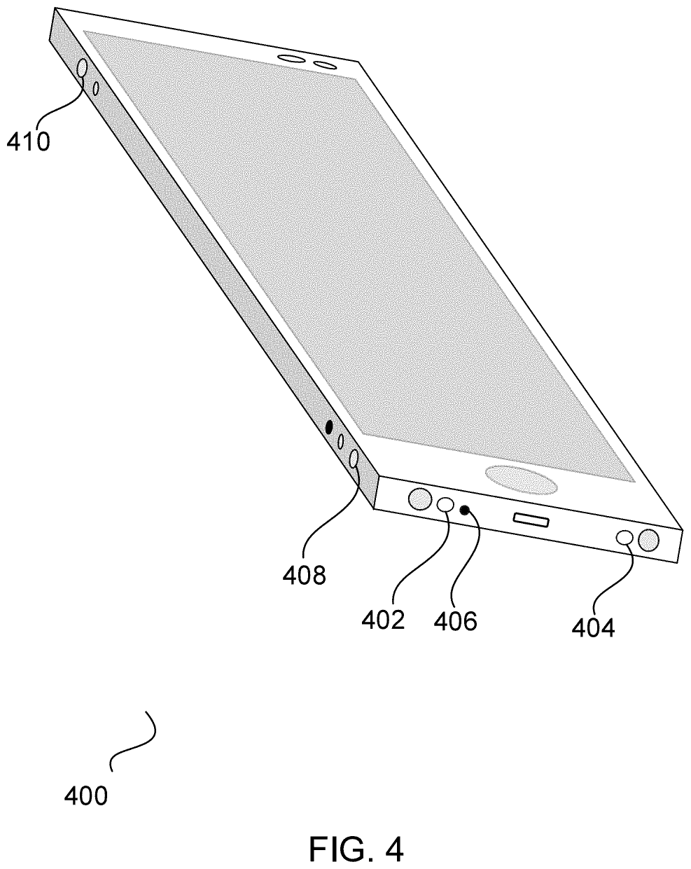

FIG. 4 is another example perspective view 400 of the portable electronic device with multiple cameras. The figure shows the bottom and left side of the portable electronic device. In addition to the cameras and the charging port, the bottom side may comprise a third flash (C3F) 402 associated with C3 and a fourth flash (04F) 404 associated with C4. The bottom side may further comprise a first mic (M1) 406. Furthermore, the left side of the portable electron is device may comprise a seventh camera (07) 408 and an eighth camera (08) 410, both these cameras have a flash associated with them. Further the left side may include a microphone as well.

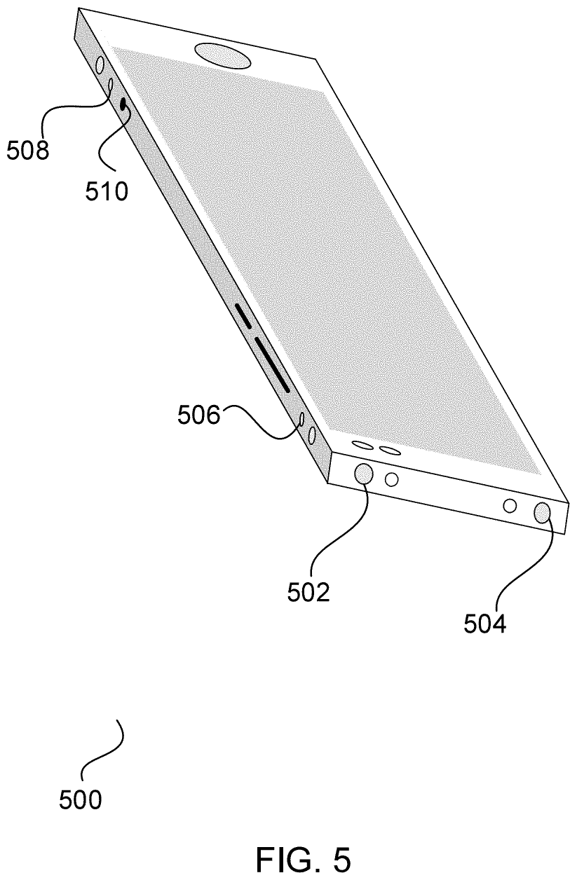

FIG. 5 is another example perspective view 500 of the portable electronic device with multiple cameras. The figure shows top side and right side of the portable electronic device. The top side may comprise a ninth camera (C9) 502 and a tenth camera (010) 504. The right side of the portable electronic device may comprise of a fifth flash (C5F) 508 and a sixth flash (06F) 506 associated with the fifth and sixth cameras (05 and C6) respectively. Furthermore, the portable electronic device may comprise a second mic (M2) 510 as well.

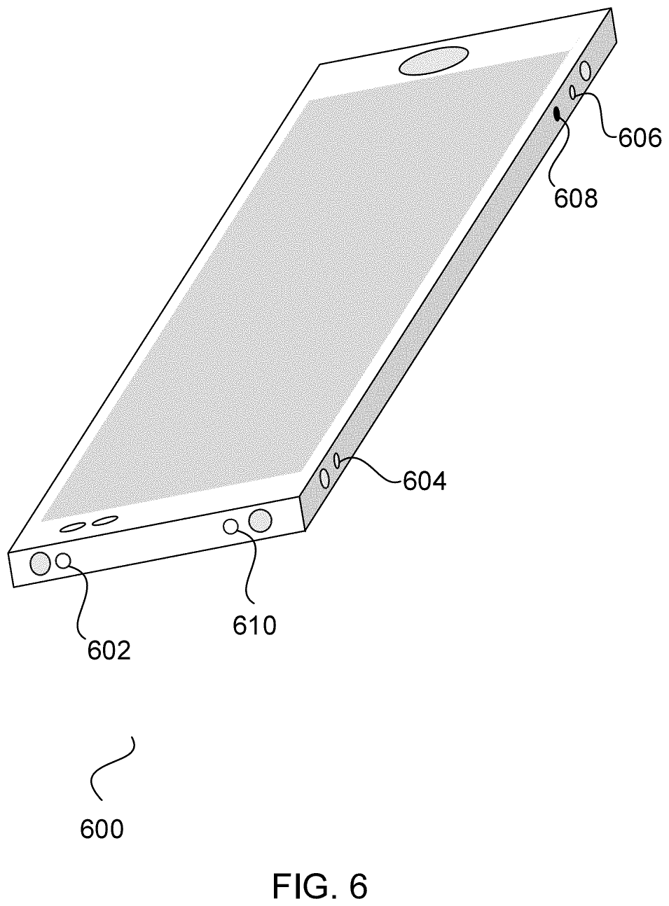

FIG. 6 is another example perspective view 600 of the portable electronic device with multiple cameras. The figure shows the top and left side of the portable electronic device. The portable electronic device may comprise a top flash 602 on the top side. Further, the left side of the portable electronic device may comprise a seventh flash (C7F) 606 associated with C7 and an eight flash (C8F) 604 associated with C8. Furthermore, the left side may include a third microphone (M3) 608. The portable electronic device may further comprise of a slot 610 for audio output (headphones) wherein any compatible earphones/headphones may be plugged in.

The embodiment described in the examples described here includes up to 10 cameras, 9 flashes and 3 microphones. The example described herein is merely for the purpose of illustration, the device may be modified to include or remove cameras and microphones as required based on the use case. The captured images may be stored locally and/or uploaded in a cloud storage simultaneously upon capturing the images. The images may be processed and stored separately or appended to form a single 360-degree image or a 360-degree live/offline video. A software program may be used in the portable electronic device to connect with the cloud for uploading and processing the imagesNideos. The portable electronic device may communicate with the cloud via a network. The network may be wired/wireless and may use technologies such as Wi-Fi, 3G, IR, GPRS, 4G, and 5G may be used to connect the electronic device with the cloud. The processing may be performed within the electronic device or in the cloud. The storage may also be cloud based so that the data is always available for consumption.

Embodiments described herein discloses an electronic device that may capture images from up to 10 cameras located at different sides of the electronic device. The electronic device may have the capability to control the operation of all the cameras connected to it. One or more cameras may be activated by the electronic device at the same time. The electronic device may have the capability to capture images from multiple cameras simultaneously. In one example, the cameras may be made available on all 6 sides of the electronic device i.e., front side, rear side, top side, bottom side, left side, and right side of the electronic device.

At any point of time, one or more cameras may be activated and used by the electronic device to capture images. If the view from one of the camera is blocked, the electronic device may be smart enough to identify this and stop capturing images from the blocked camera to save memory and processing power. Alternatively, the electronic device may alert a user if it detects any object blocks the field of view of the cameras.

In one example, the cameras may be used for recording images simultaneously from all the angles thereby providing a 360-degree view. The electronic device may be held by a person to provide a Point of View (POV) recording or may be mounted to any supporting apparatus such as a tripod to get a 360-degree view of a different perspective. The electronic device may be configured to store the inputs received from all the cameras separately within the device as well as in a cloud storage system. In addition to maintaining the images separately, the electronic device may also be configured to append all these images to produce a continuous 360-degree image and store the same locally as well as in the cloud.

Elaborating the use case described above, a user may capture a moment (let us take a scenario when the user is surfing in, a beach) using the electronic device. The user may either be capturing a still image or a video depending on the situation and the interest of the user. The portable electronic device may herein capture complete 360-degree view of the user surfing in the beach and combine them to create an image of video feed. The generated feed may be stored locally or in a cloud based storage and may be viewed in any compatible 360-degree viewings video/image player. In one example, the feed may be viewed using a virtual reality (VR) headset to provide an immersive experience and realistic experience with a 360-degree video combined with spatial audio.

The portable electronic device described herein may be used to capture images within all angles at the same time. The portable electronic device may include a processor including a System on Chip (SoC), memory, storage, networking capabilities, speakers, batteries, and the like. Example processor can be custom made or commercially available processor, a central processing unit (CPU), an auxiliary processor, a semiconductor-based microprocessor (in the form of a microchip or chip set, for example), a macro processor, or generally any device for executing computer-readable program code. Example memory may be a computer-readable storage medium. In some examples, memory can have a distributed architecture, where various components are situated remote from one another may be used. Processors may be configured to execute software stored within associated one of memories, to communicate data to and from the memory, and to generally control operations of applications running in memory pursuant to the computer-readable program code.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

A person ordinarily skilled in the art may be able to understand various use cases of the pillow and apply them accordingly in real-life conditions. The illustrations, examples and use cases described herein does not affect the scope of the invention.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A portable electronic device comprising:
a processor;
a memory communicatively coupled with the processor;
at least 10 cameras connected to the portable electronic device wherein a first camera is connected to the front side, a second camera is connected to the rear side, third and fourth cameras are connected to the bottom side, fifth and sixth cameras are connected to the right side, seventh and eighth cameras are connected to the left side, and ninth and tenth cameras are connected to the top side of the portable electronic device, wherein each of the cameras capture a plurality of images simultaneously and transmits them to the processor, and wherein the processor combines the plurality of images to generate a 360-degree image or video output.

2. The portable electronic device of claim 1, further comprising:
at least 9 flash modules connected to the electronic device, wherein the first flash module is connected to the front side, a second flash module is connected to the rear side, third and fourth flash modules are connected to the bottom side, fifth and sixth flash modules are connected to the right side, seventh and eighth flash modules are connected to the left side, and a ninth flash module is connected to the top side of the portable electronic device.

3. The portable electronic device of claim 1, further comprising at last three microphones connected to the electronic device, wherein a first microphone is connected to the bottom side, a second microphone is connected to the right side, and a third microphone module is connected to the left side of the portable electronic device.

4. The portable electronic device of claim 3, wherein the microphones capture audio when the cameras are made to record a video.

5. The portable electronic device of claim 4, wherein the microphone records audio relative to the cameras connected to their respective sides.

6. The portable electronic device of claim 5, wherein the generated 360-degree video or image can be viewed using a virtual reality (VR) headset.

7. The portable electronic device of claim 1, wherein the captured images are streamed or stored in a cloud based storage.

8. The portable electronic device of claim 1, wherein the cameras are used for recording 360-degree images or video.

9. The portable electronic device of claim 8, wherein the recorded 360-degree images or video are used for entertainment, monitoring, or surveillance.

10. The portable electronic device of claim 1, further comprises:
a rechargeable battery;
an audio output port; and
a power input port for charging the rechargeable battery.

11. The portable electronic device of claim 1, further comprises a pair of speakers to output audio while playing audio or video feed in the portable electronic device.
